(19) United States
(12) Patent Application Publication
(10) Pub. No.: US 2020/0299317 A1
(43) Pub. Date: Sep. 24, 2020

(54) Manufacturing Method of Ferric Citrate

(71) Applicant: Tokuyama Corporation, Shunan-shi (JP)

(72) Inventors: Takayuki Miyaoku, Shunan-shi (JP); Kohei Saito, Shunan-shi (JP)

(21) Appl. No.: 16/642,135

(22) PCT Filed: Jan. 22, 2019
(86) PCT No.: PCT/JP2019/001832

§ 371 Date: Feb. 26, 2020

(30) Foreign Application Priority Data
Jan. 22, 2018 (JP) 2018-008118

(51) Int. Cl. C07F 15/02

(52) U.S. Cl. CPC C07F 15/025

(57) ABSTRACT

A method of manufacturing is provided for obtaining ferric citrate by a simple drying operation, the ferric citrate having a high purity, a high specific surface area, and a reduced water-soluble organic solvent content. The method of manufacturing ferric citrate, comprises a wet material of ferric citrate, containing the ferric citrate and a water-soluble organic solvent and having a water-soluble organic solvent content within the range of more than 0.3% by mass to 30.0% by mass or less, dried by bringing a gas containing water into contact.

### TECHNICAL FIELD

The present invention relates to a new manufacturing method of ferric citrate.

### BACKGROUND ART

Ferric citrate is a compound containing both ferric iron that is trivalent iron and a molecular structure derived from citric acid, and it is known that the ferric citrate can be suitably used as a remedy for hyperphosphatemia in patients with renal failure (see Patent Literature 1 or 2).

Herein, it is known that: the ferric citrate is dissolved in blood, and a ferric phosphate compound, occurring when a ferric ion binds to a phosphate, precipitates in the digestive tract, whereby the phosphate in blood is removed from the body; and further the citric acid derived from the ferric citrate is converted into a bicarbonate, whereby the symptoms of patients with renal failure can be improved.

As a manufacturing method of such ferric citrate, Patent Literatures 1 and 2 disclose a method in which: ferric hydroxide is generated by reacting ferric chloride hexahydrate with an alkali such as sodium hydroxide; then, an aqueous solution containing the ferric citrate is obtained by reacting the ferric hydroxide with citric acid in the aqueous solution; and after that, the ferric citrate is manufactured by being precipitated as a solid with the aqueous solution added dropwise to a water-soluble organic solvent such as acetone.

On the other hand, when ferric citrate is used as a treatment for hyperphosphatemia, it is necessary to dissolve a large amount of the ferric citrate in blood. So, Patent Literatures 1 and 2 disclose a method of obtaining amorphous ferric citrate having a high dissolution rate and a high solubility in blood by the above method. Further, in Patent Literature 2, it is described that ferric citrate having a BET specific surface area of 20 to 45 m²/g can be obtained.

After a wet material of ferric citrate is obtained by solid-liquid separating the ferric citrate obtained by the above method with the use of a method such as centrifugation, vacuum drying at ambient temperature, drying by a drying method such as fluidized bed drying, grinding using a mortar or the like, and sieving are repeated multiple times, whereby a dried material of the ferric citrate can be obtained. It is also disclosed in Patent Literature 2 that simple drying or vacuum drying is performed as a drying method of a wet material of ferric citrate.

### CITATION LIST

### Patent Literature

Patent Literature 1: JP 4964585 B2

Patent Literature 2: JP 5944077 B1

### SUMMARY OF INVENTION

### Technical Problem

By the manufacturing method described in the above Patent Literatures, ferric citrate having a large specific surface area can be manufactured, but there is room for improvement in the drying operations using the method described in Patent Literature 1 because they are very complicated. On the other hand, as a result of the study on simple drying methods, such as vacuum drying, by the present inventors, it has been found that the water-soluble organic solvent contained in the ferric citrate is difficult to be reduced only by vacuum drying. Specifically, it has been found that approximately 0.3 to 2.8% by mass of a water-soluble organic solvent remains in the ferric citrate after vacuum drying, regardless of drying temperature or vacuum pressure. With respect to the limit values of the contents of organic solvents in active pharmaceutical ingredients, a guideline is provided in ICH Guideline Q3C, and, for example, acetone is classified as class 3 and the limit value is 0.5% by mass or less. As a matter of course, it is desirable that the limit value is less within the range. However, it has been found, as described above, that it may be difficult to meet the limit value of the above guideline only by vacuum drying. Also, when the specific surface area of the ferric citrate was large, the water-soluble organic solvent is more difficult to be reduced, and specifically, when the specific surface area of the ferric citrate was approximately 20 m²/g, a water-soluble organic solvent content was 0.3 to 1.3% by mass after vacuum drying; when the specific surface area was approximately 40 m²/g, the content was 0.5 to 1.9% by mass; and when the specific surface area was more than approximately 60 m²/g, the content was 0.7 to 2.8% by mass. From the above, it has become clear that when ferric citrate having a large specific surface area is manufactured, reduction of a water-soluble organic solvent is a problem.

On the other hand, in fluidized bed drying, heat drying is generally performed by bringing a heating medium, such as hot air or steam, and an object to be dried into contact with each other, and according to it, the content of a water-soluble organic solvent contained in ferric citrate can be smaller than or equal to the limit value of the guideline. However, it has been found from the study by the present inventors that not only ferric citrate is unstable to heat and the purity of ferric citrate is greatly decreased by the drying method, but also the specific surface area is greatly decreased similarly.

That is, an object of the present invention is to provide a manufacturing method for obtaining ferric citrate by a simple drying operation, the ferric citrate being able to be suitably used as a medicine, the purity and the specific surface area of the ferric citrate being high, and an organic solvent content being reduced.

### Solution to Problem

In order to solve the above problems, the present inventors have intensively studied a method of drying ferric citrate. As a result, it has been found that by performing so-called humidity control drying in which a wet material of ferric citrate, containing a large volume of a water-soluble organic solvent, is dried under an atmosphere containing water, the water-soluble organic solvent contained in the ferric citrate can be reduced without performing heat drying, and further the purity and the specific surface area of the ferric citrate obtained by the above drying method can be maintained at the levels before the drying, whereby the present invention has been completed. That is, the present invention is a manufacturing method of ferric citrate, in which a wet material of ferric citrate, having a water-soluble organic solvent content within a range of more than 0.3% by mass to 30.0% by mass or less, is dried while bringing it into contact with a gas containing water. Further, the present invention can suitably take the following aspects.

1) The contact of the gas containing water is performed at 5 to 60° C.

2) The relative humidity of the gas containing water is 20 to 95 RH %.

3) The water-soluble organic solvent is at least one type selected from acetone, methyl ethyl ketone, methanol, ethanol, 1-propanol, isopropyl alcohol, 2-butanol, t-butanol, acetonitrile, propionitrile, dimethyl ether, tetrahydrofuran, tetrahydropyran, and dioxane.

4) After a wet material of ferric citrate, having a water-soluble organic solvent content within the range of more than 0.3% by mass to 30.0% by mass or less based on the ferric citrate, is prepared by drying a wet material of ferric citrate under an atmosphere not containing water, the wet material of ferric citrate is dried while bringing it into contact with a gas containing water.

Another aspect of the present invention is ferric citrate having a water-soluble organic solvent content of 0.25% by mass or less and a specific surface area of 24.5 m²/g to 88.7 m²/g.

### Advantageous Effects of Invention

According to the manufacturing method of the present invention, ferric citrate, having a water-soluble organic solvent content, a purity, and a specific surface area that are at suitable levels for being used as an active pharmaceutical ingredient, can be manufactured by a simple drying operation. Further, ferric citrate, having small variability between manufactures and stably having equivalent quality, can be manufactured.

### DESCRIPTION OF EMBODIMENTS

In the manufacturing method of the present invention, so-called humidity control drying is performed, in which a wet material of ferric citrate, containing ferric citrate and a water-soluble organic solvent (hereinafter, may be referred to as a “wet material of ferric citrate”, or may be simply referred to as a “wet material”), the wet material containing the water-soluble organic solvent in a volume of more than 0.3% by mass to 30.0% by mass or less, is dried while bringing it into contact with a gas containing water. In the present invention, the “drying” means that the water-soluble organic solvent content in the wet material is reduced. With such a manufacturing method of the present invention, the water-soluble organic solvent content in the wet material can be greatly reduced. Although details are not clear about why the water-soluble organic solvent content in the wet material can be greatly reduced by the manufacturing method of the present invention, the present inventors guess as follows. That is, the ferric citrate obtained by the manufacturing method described in the above Patent Literatures has an amorphous shape. Therefore, when the water-soluble organic solvent used as a precipitation solvent for ferric citrate is incorporated into the ferric citrate, it is assumed that a physical action may be working between the water-soluble organic solvent and the ferric citrate, or a chemical bond (e.g., a coordinate bond with ferric iron of the ferric citrate, a hydrogen bond with citric acid, or the like) may be formed. Further, when the specific surface area of ferric citrate is large, the ferric citrate has a more complicated structure, and hence it is assumed that the water-soluble organic solvent may be easy to be incorporated into the ferric citrate. Therefore, it is assumed that the water-soluble organic solvent may be difficult to be reduced by simple vacuum drying, and in that case, and it is assumed that it may be necessary to repeat grinding and drying. Also, an effect of crushing ferric citrate is exerted in fluidized bed drying by the contact between a heat media, such as hot air or steam, and the ferric citrate, and hence it is assumed that the water-soluble organic solvent in a wet material can be efficiently reduced. However, it is assumed that a purity and a specific surface area may be decreased by the heat medium. On the other hand, in the method of the present invention, drying is performed by bringing a gas containing water into contact with the wet material, and hence it is assumed that: with the gas containing water penetrating into the wet material, the physical action between the water-soluble organic solvent and the ferric citrate may disappear, or the chemical bond may be broken; and as a result of it, the water-soluble organic solvent can be reduced without the need for heating. Hereinafter, the manufacturing method of the present invention will be described in detail.

(Wet Material of Ferric Citrate)

In the manufacturing method of the present invention, a wet material of ferric citrate, containing ferric citrate and a water-soluble organic solvent, is not particularly limited, and those that are commercially available for the use of reagents or food additives or those that have been manufactured by the publicly known methods can be used. One example of the publicly known manufacturing methods includes the method described in Patent Literatures 1 and 2. Specifically, ferric chloride hexahydrate is first dissolved in water, and is then hydrolyzed by adding sodium hydroxide, whereby ferric hydroxide, such as ferrihydrite, is obtained. The obtained ferric hydroxide is reacted with citric acid in water, whereby ferric citrate is generated. After the ferric citrate is precipitated from the solution containing the ferric citrate by using an organic solvent, a solid, obtained after solid-liquid separation and, if necessary, separation by a water-soluble organic solvent, is washed, whereby a wet material can be manufactured.

As another manufacturing method, a suspension containing ferric citrate may be prepared, in which: for example, a wet material manufactured by the above manufacturing method, ferric citrate obtained by drying the wet material, commercially available ferric citrate, or the like is dissolved in water or a citric acid aqueous solution, whereby an aqueous solution containing ferric citrate is prepared; and the aqueous solution is added dropwise to a water-soluble organic solvent. Or, a suspension containing ferric citrate may be prepared by simply mixing ferric citrate and a water-soluble organic solvent together. A wet material can be manufactured by solid-liquid separating the suspension prepared by each method, and by washing the solid obtained after the separation with a water-soluble organic solvent.

In the wet material manufactured as described above, the purity of the ferric citrate is usually 90.0 to 99.9% when analyzed by liquid chromatography (HPLC) under the conditions described in Examples, although the purity varies depending on manufacturing conditions, and the like. The BET specific surface area of the ferric citrate is usually more than 20 m²/g, when analyzed by a nitrogen absorption method under the conditions described in Examples. Therefore, the wet material, manufactured as described above in the manufacturing method of the present invention, can be suitably used.

(Water-Soluble Organic Solvent)

In the present invention, an example of the water-soluble organic solvent in the wet material includes, for example, an organic solvent that can be mixed with water at any ratio, and it specifically includes an organic solvent having a solubility in 100 parts by mass of water at 25° C. of 20 parts by mass or more. In manufacturing the above wet material, when the water-soluble organic solvent to be used for obtaining the suspension containing ferric citrate, or the water-soluble organic solvent to be used as the washing solvent after the solid-liquid separation, is used, the water-soluble organic solvent is contained in the wet material as a result. Specific examples of the water-soluble organic solvent include: ketones such as acetone, methyl ethyl ketone, acetylacetone, and diacetone alcohol; alcohols such as methanol, ethanol, 1-propanol, isopropyl alcohol, 2-butanol, t-butanol, allyl alcohol, tetrahydrofuryl alcohol, furfuryl alcohol, and propargyl alcohol; nitriles such as acetonitrile and propionitrile; ethers such as dimethyl ether, tetrahydrofuran, tetrahydropyran, and dioxane; esters such as methyl formate and methyl acetate; sulfur-containing compounds such as dimethyl sulfoxide; nitrogen-containing compounds such as N,N-dimethylformamide, N-methylpyrropidone, and acetamide; and the like. Any of the water-soluble organic solvents including reagent- and industrial-grade can be used without being particularly limited. These water-soluble organic solvents may be used alone or in combination of two or more. Of these, acetone, methyl ethyl ketone, methanol, ethanol, 1-propanol, isopropyl alcohol, 2-butanol, t-butanol, acetonitrile, propionitrile, dimethyl ether, tetrahydrofuran, tetrahydropyran, and dioxane are more preferable from the viewpoints that ferric citrate having a high purity and a high specific surface area can be obtained and that the water-soluble organic solvent is efficiently reduced at drying; acetone, methyl ethyl ketone, methanol, ethanol, 1-propanol, isopropyl alcohol, acetonitrile, and tetrahydrofuran are still more preferable; and acetone, methanol, ethanol, isopropyl alcohol, acetonitrile, and tetrahydrofuran are most preferable. Herein, water-insoluble organic solvents, including, for example, hydrocarbons such as toluene and halogenated hydrocarbons such as chloroform, may be contained in the wet material, but in order to make the drying easier, it is preferable that they are not contained.

(Water-Soluble Organic Solvent Content in Wet Material)

In the manufacturing method of the present invention, a wet material, containing a water-soluble organic solvent in a volume within the range of more than 0.3% by mass to 30.0% by mass or less based on the wet material, is dried while bringing it into contact with a gas containing water. If the water-soluble organic solvent content in the wet material is more than 30.0% by mass, there is a tendency that the specific surface area of the ferric citrate may be greatly decreased at the above drying, and hence it is not preferable. Although the reason is not clear, it is assumed that: the wet material may absorb moisture while being dried while bringing it into contact with a gas containing water; and part of the ferric citrate may be solidified after once dissolved, whereby the specific surface area is decreased. Within the above range, the water-soluble organic solvent content in the wet material, when dried by bringing a gas containing water into contact, is more preferably more than 0.3% by mass to 25.0% by mass or less from the viewpoints that the time required for the drying is shorter and the decrease in the specific surface area can be further suppressed and that the effect of reducing the water-soluble organic solvent, of the present invention, can be obtained more remarkably; still more preferably more than 0.4% by mass to 20.0% by mass or less; and the most preferably more than 0.5% by mass to 15.0% by mass or less. The water-soluble organic solvent content in the wet material can be confirmed by analysis of the wet material with the use of gas chromatography.

When the water-soluble organic solvent contained in the wet material is within the above ranges, the wet material as it is can be used as a wet material with which a gas containing water is brought into contact in the manufacturing method of the present invention. When a wet material is manufactured by the manufacturing method of a wet material described in the above section (wet material of ferric citrate), ferric citrate is precipitated with a water-soluble organic solvent containing water, and hence when a wet material is obtained by such a method, the water-soluble organic solvent is inevitably contained in the wet material. Although varied depending on manufacturing conditions and manufacturing scale, the water-soluble organic solvent is usually contained in the wet material in a volume of 40.0 to 75.0% by mass, and hence it is necessary to adjust the water-soluble organic solvent content in the wet material, for example, by the later-described drying performed under an atmosphere not containing water, so that the content falls within the range of more than 0.3% by mass to 30.0% by mass or less.

(Drying Performed Under Atmosphere not Containing Water)

An example of the method of adjusting the water-soluble organic solvent content in the wet material to be within the range of more than 0.3% by mass to 30.0% by mass or less includes a method in which the water-soluble organic solvent is reduced by drying the wet material containing the water-soluble organic solvent in a volume of more than 30.0% by mass under an atmosphere not containing water (moisture). Herein, the atmosphere not containing water means the case where water is not substantially contained in an apparatus used for drying the wet material, or the case where water, if any, is contained less than 5 RH %. Specific examples of such a drying method include: reduced-pressure drying, aeration drying using inert gas, such as nitrogen or argon, or dry air; and the like. Of these, the reduced-pressure drying, the first method, is more preferable in view of efficient reduction of the water-soluble organic solvent. As the conditions of the reduced-pressure drying, a degree of reduced pressure is preferably 0.001 to 50.0 kPa, and within this, more preferably 0.001 to 40.0 kPa in view of efficient reduction of the water-soluble organic solvent, and most preferably 0.001 to 30.0 kPa. A drying temperature is preferably 5 to 60° C., and within this, more preferably 10 to 50° C. in view of efficient reduction of the water-soluble organic solvent and the stability of the ferric citrate, and most preferably 15 to 40° C. An apparatus to be used is only required to be an apparatus that is industrially available, and examples of it include a shelf-type dryer, a conical dryer, and the like. It is more preferable to perform reduced-pressure drying under rotation by using a conical dryer, since the drying is more excellent in efficient reduction of the water-soluble organic solvent and uniformity. Since a time necessary for the drying varies depending on drying conditions, manufacturing scale, and the like, it is difficult to define in general, but it may be defined by confirming, with the use of a technique such as gas chromatography (GC) under the conditions described in Examples, that the water-soluble organic solvent content in the wet material falls within the range of more than 0.3% by mass to 30.0% by mass or less. When there are multiple water-soluble organic solvents, the total of the contents of the respective solvents in the wet material should fall within the range of more than 0.3% by mass to 30.0% by mass or less.

(Drying by Bringing into Contact with Gas Containing Water)

In the manufacturing method of the present invention, so-called humidity control drying is performed, in which a wet material, containing a water-soluble organic solvent in a volume within the range of more than 0.3% by mass to 30.0% by mass or less based on the wet material, is dried while bringing it into contact with a gas containing water. The humidity control drying means that an object to be dried is dried by bringing into contact with a gas containing water. Specific examples of the gas containing water include gases, such as air, nitrogen, and argon, containing water. Of these, air containing water is preferably used from the viewpoint of easy adjustment. The water content in the gas may be appropriately determined in consideration of the amount of the wet material to be provided for the drying treatment, the water-soluble organic solvent content, and the like; but the content is preferably 20 to 95 RH % as relative humidity, from the viewpoint of efficient drying of the wet material. As long as within this range, the water content in the gas to be brought into contact in the middle of the drying may be appropriately changed. Within the above range, the content is more preferably 25 to 90 RH % in view of efficient reduction of the water-soluble organic solvent and the stability of the ferric citrate, still more preferably 30 to 85 RH %, and most preferably 35 to 80 RH %. Herein, the relative humidity means a relative humidity at the temperature at drying.

As the method of contacting the wet material and the gas containing water together, a method, publicly known as a humidity control drying method, can be adopted. Specific examples of the method include a method of leaving the wet material under an atmosphere containing water, a method of aerating a gas containing water in a drying apparatus that houses the wet material, and the like. From the viewpoint of increasing a drying efficiency by improving a contact efficiency between the wet material and the gas containing water, a method is preferable, in which the gas containing water is aerated while the wet material is being rotated or stirred. The drying apparatus is only required to be capable of bringing the wet material and the gas containing water into contact with each other, and an apparatus that is generally used industrially, such as a shelf type, an evaporator, and a rotary apparatus including a conical dryer, or the like, may be used. Its material is not particularly limited, but an apparatus, made of glass, stainless steel, Teflon (registered trademark), glass lining, or a metallic material, may be adopted. Further, the apparatus is preferable to install a thermometer, a pressure gauge, a hygrometer, and the like.

The temperature at the drying is preferably 5 to 60° C. As long as within this range, the temperature may be appropriately changed in the middle of the drying. Within the above range, the temperature is more preferable to be 10 to 50° C. in view of efficient reduction of the water-soluble organic solvent and the stability of the ferric citrate, and is most preferably 15 to 40° C.

A drying time may be appropriately determined by confirming that it becomes a desired volume, by measuring the volume of the water-soluble organic solvent contained in the wet material with GC or the like. Although varied depending on drying conditions, manufacturing scale, the type of the water-soluble organic solvent, and the like, the water-soluble organic solvent content can usually be made at least 0.5% by mass or less % in 1 to 100 hours. However, if the drying time is too long, the quality and economic performance of the ferric citrate are decreased, and hence it is preferable to stop the drying when the content becomes a desired volume within the range of at least 0.5% by mass or less.

When the wet material contains lumps and the like before or amid the drying, the wet material may be ground by a publicly known grinder such as a mortar, a power mill, or a pin mill, or the wet material may be sieved, or the like.

(Ferric Citrate)

The ferric citrate in which a water-soluble organic solvent content is greatly reduced can be obtained as described above. The volume of the water-soluble organic solvent contained in the ferric citrate can be reduced to at least 0.5% by mass or less. Since the effect of reducing the water-soluble organic solvent is very high in the present invention, ferric citrate can be manufactured, in which the water-soluble organic solvent content in the ferric citrate is more preferably 0.25% by mass or less, still more preferably 0.1% by mass or less, and most preferably 0.05% by mass or less. Although it is desirable that the lower limit of the content is 0% by mass, the detection limit in the method of measuring a content, described in Examples, is 0.005% by mass (50 ppm). The ferric citrate of the present invention has a higher purity and a higher specific surface area than ferric citrate containing a water-soluble organic solvent in a volume of 0.5% by mass or less, which is obtained by a conventional method, and hence the ferric citrate can be suitably used in pharmaceutical applications.

Another aspect of the present invention is ferric citrate having a water-soluble organic solvent content of 0.25% by mass or less and a specific surface area of 24.5 m²/g to 88.7 m²/g. The ferric citrate of the present invention can be used in pharmaceutical applications. The water-soluble organic solvent content in the ferric citrate is preferably 0.1% by mass or less, and more preferably 0.05% by mass or less, and the specific surface area of the ferric citrate is preferably 46.0 m²/g to 88.7 m²/g, and more preferably 65.0 m²/g to 88.7 m²/g.

### EXAMPLES

Hereinafter, the present invention will be described in detail based on Examples, but the invention should not be limited at all by these Examples.

The water-soluble organic solvent content in ferric citrate of Examples and Comparative examples were measured by gas chromatography (GC). A sample was introduced into GC by using a headspace (HS). The purity of ferric citrate (hereinafter, may be simply referred to as the “purity”) was measured by high performance chromatography (HPLC), and the specific surface area was measured by a nitrogen absorption method. The apparatus used in each measurement and measurement conditions are as follows.

(Water-Soluble Organic Solvent Content)

The water-soluble organic solvent content in a wet material or ferric citrate was measured under the following conditions.

Apparatus: gas chromatograph apparatus (made by Agilent Technologies, Inc.)

Detector: hydrogen flame ionization detector (made by Agilent Technologies, Inc.)

Column: the inner surface of a fused silica tube having an inner diameter of 0.53 mm and a length of 30 m was coated with polyethylene glycol for gas chromatography at a thickness of 1 μm.

Column temperature: 50° C. for 6 minutes after injection, then increased to 220° C. at a rate of 40° C./min, and maintained at 220° C. for 5 minutes.

Column pressure: 3 psi

Injection temperature: 250° C.

Detector temperature: 250° C.

Carrier gas: helium

Split: 1/10

Headspace heating temperature: 90° C.

Headspace heating time: 30 minutes

In the following examples and comparative examples, the water-soluble organic solvent content in a wet material or ferric citrate is a ratio of the mass of the water-soluble organic solvent to the mass of the wet material, the content being determined by a calibration curve method from the peak area value of the water-soluble organic solvent measured under the above conditions.

(Purity)

The purity of ferric citrate was measured under the following conditions.

Apparatus: liquid chromatograph apparatus (made by Waters Corporation)

Detector: ultraviolet absorptiometer (made by Waters Corporation)

Measurement wavelength: 210 nm

Column: stainless tube having an inner diameter of 4.6 mm and a length of 250 mm and being filled with 5-μm octadecylsilylated silica gel for liquid chromatography

Mobile phase: mixed liquid obtained by adding 12.0 g of sodium dihydrogen phosphate to 2000 mL of water and dissolving it, the pH of which was adjusted to 2.2 by adding phosphoric acid.

Flow rate: 1.0 mL/min

Column temperature: constant temperature near 30° C.

Measuring time: 30 minutes

In the following examples and comparative examples, the purity of ferric citrate is a ratio of the peak area value of citric acid to the total of the area values of all the peaks (except for the peaks derived from iron and a solvent) measured under the above conditions.

(Specific Surface Area)

The specific surface area of ferric citrate was measured under the following conditions.

Apparatus: specific surface area measuring apparatus (made by MicrotracBEL Corp.)

Measuring method: constant-volume nitrogen adsorption method

Sample volume: approximately 100 mg

Pretreatment temperature: 40° C.

Pretreatment time: 1 hour

In the following examples and comparative examples, when the partial pressure of nitrogen was within the range of 0.1 to 0.3, a nitrogen absorption volume at each partial pressure was measured under the above conditions, and the specific surface area of ferric citrate was analyzed and calculated from the partial pressure and the nitrogen adsorption volume by a BET method.

### Manufacturing Example (Manufacturing of Wet Material of Ferric Citrate)

Wet materials of ferric citrate to be used in the following examples and comparative examples were manufactured by the following method. To a 5 L 4-neck flask with stirring blades and thermometers, 400.0 g of iron chloride hexahydrate and 1600 mL of water were added and stirred. Next, an aqueous solution prepared from 177.6 g of sodium hydroxide and 1600 mL of water was added dropwise at 0 to 10° C. over 3 hours. Next, after stirring at 0 to 10° C. for 1 hour, precipitates were separated by centrifugation, and the precipitates after the separation were washed twice with 100 mL of water. Next, 2000 mL of water was added to the obtained precipitates, and they were stirred at 0 to 10° C. for 1 hour. The precipitates were separated by centrifugation, and the precipitates after the separation were washed twice with 100 mL of water. Further, 2000 mL of water was added to the obtained precipitates, and they were stirred at 0 to 10° C. for 1 hour. The precipitates were separated by centrifugation, and the precipitates after the separation were washed twice with 100 mL of water.

To a 5 L 4-neck flask with stirring blades and thermometers, 369.6 g of citric anhydride and 480 mL of water were added and stirred. Next, the precipitates obtained in the above were added, and they were stirred at 20 to 30° C. for 30 minutes. Further, they were heated to approximately 80° C. and stirred at 75 to 85° C. for 2 hours. After cooled to approximately 25° C., they were filtered by a PTFE filter having a pore size of 0.5 μm to remove insoluble matters, whereby a filtrate was obtained. To 8000 mL of acetone, the obtained filtrate was added dropwise at 20 to 30° C. over 30 minutes. After they were stirred at 20 to 30° C. for 1 hour, precipitates were separated by centrifugation, and the precipitates after the separation were washed twice with 400 mL of acetone. To the obtained precipitates, 4000 mL of acetone was added and stirred at 20 to 30° C. for 1 hour. The precipitates were separated by centrifugation, and the precipitates after the separation were washed twice with 400 mL of acetone. As described above, 803.8 g of wet material of ferric citrate, containing acetone, was obtained. The acetone content in this wet material was 60.2% by mass, and the purity was 98.34%.

### Example 1

In a glass petri dish, 40.0 g of the wet material containing acetone, obtained in the manufacturing example, was put, and it was subjected to reduced-pressure drying by using a shelf-type dryer for 5 hours under conditions in which the temperature was 30° C. and the degree of reduced pressure was approximately 1 kPa. After the reduced-pressure drying, the acetone content in the wet material was 19.8% by mass, and the purity was 98.33%.

Next, it was subjected to humidity control drying for 10 hours by adjusting the inside of the dryer such that the temperature was 30° C. and the relative humidity was 60 RH %. After the drying, 15.9 g of ferric citrate was obtained. The acetone content in the ferric citrate was 0.03% by mass, and the purity was 98.33%. The specific surface area was 38.3 m²/g.

### Examples 2 to 5

Examples 2 to 5 were performed similarly to Example 1, except that the temperature and time of the reduced-pressure drying, before the drying (humidity control drying) in which a gas containing water was brought into contact, were changed. Conditions and results were shown in Table 1.

TABLE 1

| | | | | | Ferric citrate | | |
|---|---|---|---|---|---|---|---|
| | | | Wet material | | (after humidity | | |
| | | | (after reduced- | | control drying) | | |
| | Reduced-pressure | | pressure drying) | | | | Specific |
| | conditions | | Acetone | | Acetone | | surface |
| | Temperature | Time | content | Purity | content | Purity | area |
| Examples | (° C.) | (hour) | (% by mass) | (%) | (% by mass) | (%) | (m²/g) |
| 1 | 30 | 3 | 19.8 | 98.33 | 0.03 | 98.33 | 38.3 |
| 2 | 30 | 6 | 11.9 | 98.33 | 0.02 | 98.33 | 39.9 |
| 3 | 30 | 10 | 3.1 | 98.33 | 0.02 | 98.33 | 40.1 |
| 4 | 30 | 1 | 28.5 | 98.34 | 0.04 | 98.33 | 31.1 |
| 5 | 30 | 2 | 23.3 | 98.33 | 0.03 | 98.33 | 35.6 |

### Examples 6 to 15

Examples 6 to 15 were performed similarly to Example 1, except that the temperature, the relative humidity, and time of the drying (humidity control drying) in which a gas containing water was brought into contact were changed. Conditions and results were shown in Table 2.

TABLE 2

| | | | | | | Ferric citrate | | |
|---|---|---|---|---|---|---|---|---|
| | Wet material | | | | | (after humidity | | |
| | (after reduced- | | Humidity control | | | control drying) | | |
| | pressure drying) | | drying conditions | | | | | Specific |
| | Acetone | | | Relative | | Acetone | | surface |
| | content | Purity | Temperature | humidity | Time | content | Purity | area |
| Examples | (% by mass) | (%) | (° C.) | (RH %) | (hour) | (% by mass) | (%) | (m²/g) |
| 1 | 19.8 | 98.33 | 30 | 60 | 10 | 0.03 | 98.33 | 38.3 |
| 6 | 18.9 | 98.33 | 30 | 75 | 6 | 0.03 | 98.33 | 37.9 |
| 7 | 18.9 | 98.33 | 30 | 85 | 6 | 0.03 | 98.33 | 36.8 |
| 8 | 19.5 | 98.33 | 30 | 96 | 5 | 0.03 | 98.33 | 36.8 |
| 9 | 19.5 | 98.33 | 30 | 40 | 15 | 0.03 | 98.33 | 38.4 |
| 10 | 19.2 | 98.33 | 50 | 60 | 5 | 0.03 | 97.13 | 32.3 |
| 11 | 18.0 | 98.33 | 50 | 85 | 4 | 0.02 | 97.10 | 31.4 |
| 12 | 19.6 | 98.33 | 70 | 85 | 4 | 0.02 | 96.90 | 30.2 |
| 13 | 19.0 | 98.34 | 20 | 65 | 15 | 0.03 | 98.34 | 38.7 |
| 14 | 17.4 | 98.33 | 10 | 80 | 25 | 0.03 | 98.33 | 38.5 |
| 15 | 19.4 | 98.33 | 10 | 80 | 15 | 0.25 | 98.33 | 39.0 |

### Example 16

To a 100 mL 4-neck flask with stirring blades and thermometers, 1.0 g of citric anhydride and 8.5 mL of water were added and stirred. Next, 5.0 g of the ferric citrate obtained in Example 1 was added little by little over 15 minutes and stirred. After they were stirred at 25 to 35° C. for 1 hour, the obtained solution was added dropwise to 100 mL of acetone at 20 to 30° C. over 30 minutes. After they were stirred at 20 to 30° C. for 1 hour, precipitates were separated by centrifugation, and the precipitates after the separation were washed twice with 5 mL of acetone. To the obtained precipitates, 80 mL of acetone was added, and they were stirred at 20 to 30° C. for 1 hour. Precipitates were separated by centrifugation, and the precipitates after the separation were washed twice with 5 mL of acetone.

In a glass petri dish, the obtained precipitates were put, and they were subjected to reduced-pressure drying by using a shelf-type dryer for 5 hours under conditions in which the temperature was 30° C. and the degree of reduced pressure was approximately 1 kPa. After the reduced-pressure drying, the acetone content in the wet material was 9.8% by mass, and the purity was 99.93%.

Next, they were subjected to humidity control drying for 10 hours by adjusting the inside of the dryer such that the temperature was 25° C. and the relative humidity was 75 RH %. After the drying, 4.6 g of ferric citrate was obtained. The acetone content in the ferric citrate was 0.03% by mass, and the purity was 99.93%. The specific surface area was 88.7 m²/g.

### Example 17

Example 17 was performed similarly to Example 16, except that 2.9 g of citric anhydride was used. After the reduced-pressure drying, the acetone content in the wet material was 7.9% by mass, and the purity was 99.90%. Further, after the humidity control drying, the acetone content in the ferric citrate was 0.03% by mass, and the purity was 99.89%. The specific surface area was 24.5 m²/g.

### Example 18

Example 18 was performed similarly to Example 16, except that 1.4 g of citric anhydride was used. After the reduced-pressure drying, the acetone content in the wet material was 8.9% by mass, and the purity was 99.92%. Further, after the humidity control drying, the acetone content in the ferric citrate was 0.03% by mass, and the purity was 99.92%. The specific surface area was 66.4 m²/g.

### Example 19

Example 19 was performed similarly to Example 16, except that 1.8 g of citric anhydride was used. After the reduced-pressure drying, the acetone content in the wet material was 8.1% by mass, and the purity was 99.91%. Further, after the humidity control drying, the acetone content in the ferric citrate was 0.03% by mass, and the purity was 99.90%. The specific surface area was 47.8 m²/g.

### Comparative Example 1

In a glass petri dish, 40.0 g of the ferric citrate, obtained in the manufacturing example, was put, and it was subjected to reduced-pressure drying by using a shelf-type dryer for 20 hours under conditions in which the temperature was 30° C. and the degree of reduced pressure was approximately 1 kPa. After the reduced-pressure drying, the acetone content in the wet material was 0.91% by mass, and the purity was 98.33%. Further, it was subjected to reduced-pressure drying under the same conditions for 20 hours. After the reduced-pressure drying, the acetone content in the wet material was 0.92% by mass, and the purity was 98.32%. Next, the temperature was increased to 70° C., and it was subjected to reduced-pressure drying for 20 hours. After the reduced-pressure drying, the acetone content in the wet material was 0.91% by mass, and the purity was 96.93%. The specific surface area was 40.8 m²/g.

### Comparative Example 2

Comparative example 2 was performed similarly to Example 16, except that the drying (humidity control drying), in which a gas containing water was brought into contact, was not performed, and a wet material containing 9.7% by mass of acetone was obtained. Further, it was subjected to reduced-pressure drying by using a shelf-type dryer for 20 hours under conditions in which the temperature was 30° C. and the degree of reduced pressure was approximately 1 kPa. After the reduced-pressure drying, the acetone content in the wet material was 2.2% by mass, and the purity was 99.93%. Next, the temperature was increased to 70° C., and it was subjected to reduced-pressure drying for 20 hours. After the reduced-pressure drying, the acetone content in the wet material was 2.1% by mass, and the purity was 97.34%. The specific surface area was 88.9 m²/g.

### Comparative Example 3

Comparative example 3 was performed similarly to Example 17, except that the drying (humidity control drying), in which a gas containing water was brought into contact, was not performed, and a wet material containing 7.5% by mass of acetone was obtained. Further, it was subjected to reduced-pressure drying by using a shelf-type dryer for 20 hours under conditions in which the temperature was 30° C. and the degree of reduced pressure was approximately 1 kPa. After the reduced-pressure drying, the acetone content in the wet material was 0.6% by mass, and the purity was 99.90%. Next, the temperature was increased to 70° C., and it was subjected to reduced-pressure drying for 20 hours. After the reduced-pressure drying, the acetone content in the wet material was 0.5% by mass, and the purity was 97.10%. The specific surface area was 24.9 m²/g.

### Comparative Example 4

Comparative example 4 was performed similarly to Example 1, except that reduced-pressure drying was not performed (a wet material containing 60.2% by mass of acetone was subjected to humidity control drying at a temperature of 30° C. and at a relative humidity of 60 RH %). As a result, 20.6 g of a wet material was obtained. The acetone content in the wet material was 0.43% by mass, and the purity was 98.33%. The specific surface area was 11.0 m²/g.

1. A manufacturing method of ferric citrate, wherein a wet material of ferric citrate, containing the ferric citrate and a water-soluble organic solvent and having a water-soluble organic solvent content within a range of more than 0.3% by mass to 30.0% by mass or less, is dried while bringing it into contact with a gas containing water.

2. The manufacturing method of ferric citrate according to claim 1, wherein contact of the gas containing water is performed at 5 to 60° C.

3. The manufacturing method of ferric citrate according to claim 1, wherein a relative humidity of the gas containing water is 20 to 95 RH %.

4. The manufacturing method of ferric citrate according to claim 1, wherein the water-soluble organic solvent is at least one type selected from acetone, methyl ethyl ketone, methanol, ethanol, 1-propanol, isopropyl alcohol, 2-butanol, t-butanol, acetonitrile, propionitrile, dimethyl ether, tetrahydrofuran, tetrahydropyran, and dioxane.

5. The manufacturing method of ferric citrate according to claim 1, wherein the wet material of ferric citrate, having a water-soluble organic solvent content within a range of more than 0.3% by mass to 30.0% by mass or less, is prepared by drying a wet material of ferric citrate, containing more than 30% by mass of the water-soluble organic solvent, under an atmosphere not containing water.

6. Ferric citrate having a water-soluble organic solvent content of 0.25% by mass or less and a specific surface area of 24.5 m²/g to 88.7 m²/g.

7. The manufacturing method of ferric citrate according to claim 2, wherein a relative humidity of the gas containing water is 20 to 95 RH %.

8. The manufacturing method of ferric citrate according to claim 2, wherein the water-soluble organic solvent is at least one type selected from acetone, methyl ethyl ketone, methanol, ethanol, 1-propanol, isopropyl alcohol, 2-butanol, t-butanol, acetonitrile, propionitrile, dimethyl ether, tetrahydrofuran, tetrahydropyran, and dioxane.

9. The manufacturing method of ferric citrate according to claim 3, wherein the water-soluble organic solvent is at least one type selected from acetone, methyl ethyl ketone, methanol, ethanol, 1-propanol, isopropyl alcohol, 2-butanol, t-butanol, acetonitrile, propionitrile, dimethyl ether, tetrahydrofuran, tetrahydropyran, and dioxane.

10. The manufacturing method of ferric citrate according to claim 2, wherein the wet material of ferric citrate, having a water-soluble organic solvent content within a range of more than 0.3% by mass to 30.0% by mass or less, is prepared by drying a wet material of ferric citrate, containing more than 30% by mass of the water-soluble organic solvent, under an atmosphere not containing water.

11. The manufacturing method of ferric citrate according to claim 3, wherein the wet material of ferric citrate, having a water-soluble organic solvent content within a range of more than 0.3% by mass to 30.0% by mass or less, is prepared by drying a wet material of ferric citrate, containing more than 30% by mass of the water-soluble organic solvent, under an atmosphere not containing water.

12. The manufacturing method of ferric citrate according to claim 4, wherein the wet material of ferric citrate, having a water-soluble organic solvent content within a range of more than 0.3% by mass to 30.0% by mass or less, is prepared by drying a wet material of ferric citrate, containing more than 30% by mass of the water-soluble organic solvent, under an atmosphere not containing water.
